(19) United States
(12) Patent Application Publication
(10) Pub. No.: US 2022/0355381 A1
(43) Pub. Date: Nov. 10, 2022

(54) Layer Spreading and Compaction in Binder Jet 3D Printing

(71) Applicant: Desktop Metal, Inc., Burlington, MA (US)

(72) Inventors: George Hudelson, Billerica, MA (US); Alexander C Barbati, Cambridge, MA (US)

(73) Assignee: Desktop Metal, Inc., Burlington, MA (US)

(21) Appl. No.: 17/525,718

(22) Filed: Nov. 12, 2021

Related U.S. Application Data
(60) Provisional application No. 63/184,126, filed on May 4, 2021.

(51) Int. Cl. B22F 10/37; B22F 12/63; B33Y 10/00; B33Y 30/00

(52) U.S. Cl. CPC B22F 10/37; B22F 12/63; B33Y 10/00; B33Y 30/00; B22F 12/30

(57) ABSTRACT

A method of conditioning layers of build material powder for metal additive manufacturing including depositing an amount of build material powder on a work surface, the amount of build material powder having a lower surface separated from an upper surface by a height. A roller is traversed across the work surface in a first direction while rotating the roller in a direction opposed to the first direction. During the step of traversing the roller, a lower surface of the roller extends below the upper surface of the amount of build material powder by a distance. The roller has a surface conditioning configured to, in conjunction with a controlled speed of the rotation of the roller, provide a powder density in a compacted layer within a predetermined powder density range.

### RELATED APPLICATION

The present application claims priority to U.S. Provisional Patent Application No. 63/184,126, titled “Layer Spreading and Compaction in Binder Jet 3D Printing”, the entire contents of which are hereby incorporated herein in their entirety.

### TECHNICAL FIELD

Various aspects of the present disclosure relate generally to systems and methods for measuring and controlling powder bed density.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part is removed from the excess powder, and sintered at high temperature to bind the particles together.

During the powder deposition and spreading process, it is important to create a uniform distribution of powder, with a sufficiently high green density to enable subsequent sintering of the part to full density, but without disturbing the printed regions in previous layers.

During the powder spreading step of the binder jet process, a roller traverses the bed while rotating in a direction counter to the traversal direction (counter-rotating). This rotation and traversal serves to spread, smooth, and compact the powder to form a new layer into which binder may be deposited. Roller rotation speed may be controlled to cause the roller to rotate through a given amount of rotation per amount of linear travel. For example, the roller traverse speed may be set to 500 mm/s, and the roller rotation may be set to 4 degrees per mm of travel, resulting in a roller speed of 333 revolutions per minute.

In a typical binder jet printer, the roller used may be substantially smooth (that is, polished, or having a roughness Ra<0.1 μm). The surface roughness of the roller may be such that the height of a typical feature on the surface of the roller is less than about 1/10 th the size of the D10 or D50 of the powder (that is, the 10th percentile or 50th percentile of the particle diameter). With such a polished roller, the coefficient of friction between the powder and the roller may be low, such that powder in contact with the roller may experience slipping or sliding contact with the roller, causing only a small amount of motion of powder particles with a component in the direction of rotation. Thus, powder in the pile in front of the roller, rather than being tumbled or thrown by the roller rotation motion, may accumulate directly below the roller. This may cause an increase in pressure, which can compress the powder bed, and may in some cases lead to disturbance or shifting of previously printed layers, causing smearing or other defects. In some cases, the accumulation of powder under the roller may cause a jamming of the powder (that is, cause powder to undergo a transition from an easily flowing regime to a packed or jammed regime wherein powder flowability is greatly reduced), which can contribute to the presence of defects such as smearing.

### SUMMARY

Described now are systems and methods to ameliorate the above problems associated with substantially smooth rollers. Particularly, favorable powder conditioning can be achieved by intentionally providing a roller with a selected surface conditioning, for example a circumferential roughness, and simultaneously selectively controlling the speed with which the roller is traversed across a layer of powder.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a smooth roller with a low effective friction coefficient with respect to the powder in the pile ahead of the roller.

FIG. 2 depicts a roller with a surface conditioning having a higher effective friction coefficient with respect to the powder in the pile ahead of the roller.

FIG. 3. is a chart of sintered density as a function of the green density of printed parts.

FIG. 4 is a chart of relative density of a green part resulting from a printing process using a compaction roller with different levels of roughness, all other parameters held constant.

FIG. 5 is a chart showing that for a roller with a given roughness, as the roller speed increases, the relative density of a green part decreases.

FIG. 6 is a chart showing that roller rotation speed may be varied along the powder bed to counter the effects of increasing (or decreasing) pile size.

FIG. 7 depicts the measurement of roller roughness around the roller circumference and axially along the roller.

FIG. 8 depicts an embodiment roller with a wiper.

FIG. 9 depicts a pile of granular material deposited in advance of the roller to be spread across a powder bed.

FIG. 10 depicts a roller of traversing a large section of the powder bed after powder has been metered across it.

### DETAILED DESCRIPTION

Existing systems for binder jetting of metal powder typically have a single roller with a smooth surface, or multiple rollers with one roller having a rough surface for spreading powder and a second smooth roller for compressing or compacting the powder. In such systems, it has not been possible balance the competing effects of spreading powder and compressing powder using a single spreading roller. One approach to resolve this has been to rely on specially formulated powders (e.g. powders having engineered particle size distributions) which permit spreading while achieving desired powder bed or green part density. Such powders may add undesirable cost compared to more standard mass-produced powders. Another approach is to separate the spreading and compaction functions using two rollers, which may increase the cost and complexity of the system or limit the effective printing speed.

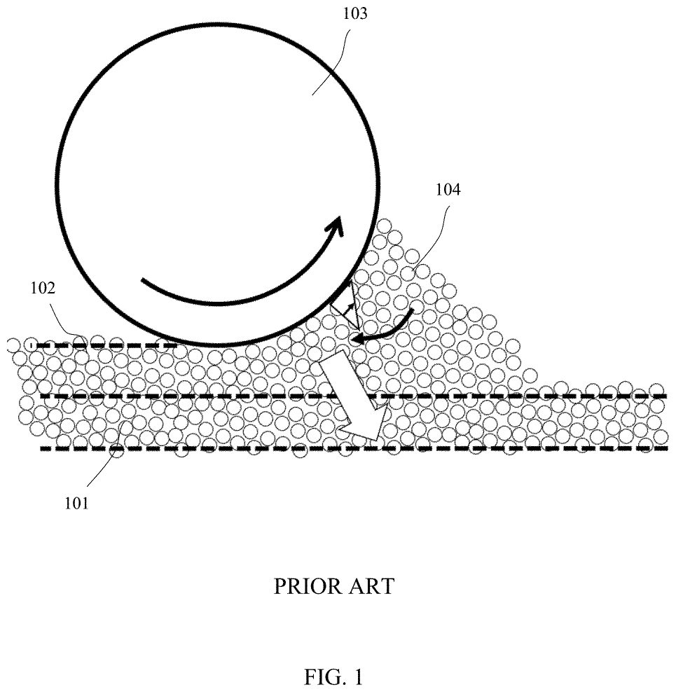

With reference to FIG. 1, during an ongoing binder jetting process there is a previous powder layer 101 over which a new powder layer 102 is being spread. A smooth roller 103 is counterrotated relative to the direction of traversal and may have a low effective friction coefficient (illustrated for understanding) with respect to the powder in a pile 105 ahead of the roller 101. This may allow particles to slip relative to the roller, allowing powder in the pile ahead of the roller to accumulate and move towards the contact point. This accumulation of powder causes the roller to apply a high force or pressure to the powder (illustrated for understanding), which can cause shifting of parts in the previously printed layers.

As described below, by including a surface conditioning on a roller, the degree of accumulation under the roller, and thus the pressure or amount of powder compression (compaction), may be directly controlled by modulating the rotation rate of the roller. Using a roller with surface conditioning, slower rotation rates may lead to a higher degree of compression, and thus a higher density, while faster rotation may lead to a lesser degree of compaction and result in a lower density and lower likelihood of causing smearing or other defects. As used herein, surface conditioning is defined as, for a given roller, a collection of raised and/or recessed micro-features selected to, in coordination with the modulation of the speed of the roller, provide a desired degree of powder compression. The surface conditioning may take the form of a selected roughness.

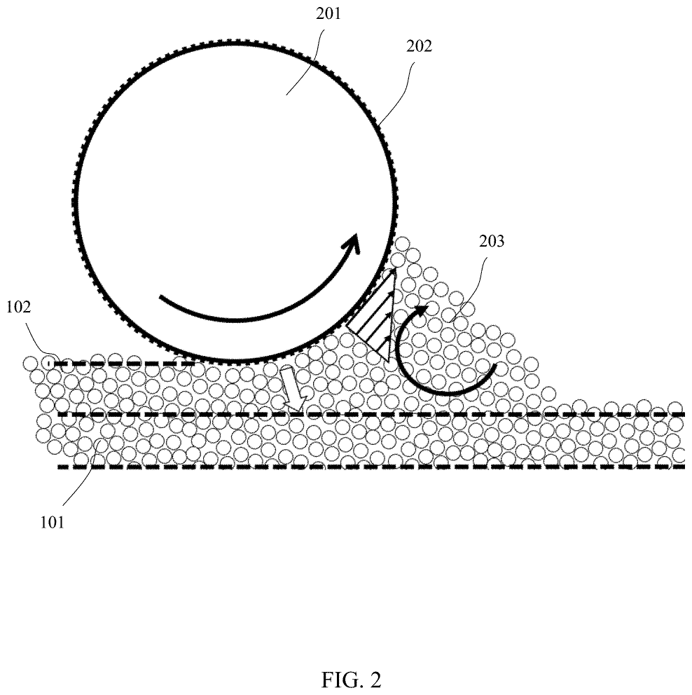

FIG. 2 depicts a roller 201 with a sufficient roughness 202 having a higher effective friction coefficient with respect to the powder in the pile 203 ahead of the roller. This may cause particles near the roller to move with a higher velocity (less slipping of particles), causing a velocity profile of particles within the pile, and resulting in a tumbling or recirculating motion of the particles in the pile of powder ahead of the roller. This in turn may reduce the pressure (or force) applied by the roller to the layer of powder. Smooth rollers lacking surface conditioning do not admit the same amount of control, and limit the size of the process window accessible during the printing process.

A binder jet process may be optimized by selecting a combination of roller surface conditioning and roller speed to give a desired degree of compaction, producing parts with sufficiently high density while avoid particle jamming, and avoiding creation of defects. Moreover, since the roller interacts with a powder having specific physical, material, and chemical characteristics (e.g., particle size distribution, roughness, shape, material type, oxidation level, cohesion, and other properties) and these characteristics may vary across powder types and affect the flow response of the material, the ability of a surface conditioned roller to affect the interaction between the roller and the powder will enable a larger processing window across powder types. In the case of a smooth roller, the action of rotation and the control of density (for one powder type or across many powder types) by changing rotation speed may not be available.

A roller may be manufactured from a metal, such as a tool steel, a stainless steel, or an alloy of aluminum, or any suitable metal. Alternatively, a roller may be made from a ceramic, carbide, or nitride such as alumina, silicon carbide, aluminum nitride, or other suitable ceramic, carbide, or nitride materials. The roller may be made from a glassy material such as a borosilicate glass, soda-lime glass, fused quartz, fused silica, or other suitable material. In certain embodiments, the roller may consist of multiple materials to utilize the hardness or abrasion resistance of a first material (like diamond, for example), while a second material is utilized for reasons of cost, toughness, ductility, density, or efficiency of manufacture (like 6061 aluminum, for example). The roller may be desired to have a high hardness (for example, a hardness greater than about 50 Rockwell Hardness C), to prevent abrasion or smoothing while in use. Abrasion may cause a roller roughness to change during use due to contact with the powder materials in use—thus a roller with a high hardness may be resistant to having its hardness change over time.

Roughness may be defined as a surface roughness profile measured and calculated using a stylus profilometer, in accordance with ISO 21920 or any similar standard method. The arithmetic average roughness, Ra, is calculated as the average deviation of the surface from a theoretical mean surface, where the measured data is filtered using spatial filtering parameters which are selected based on the level of roughness being measured. Roughness may also be measured on an area basis, or example by optical methods. The measured result from a given roughness measurement may be impacted by factors including the geometry of the stylus tip used for measurement (e.g. tip angle and tip radius), the spatial filtering factors (λs and λc), sampling length, measurement speed, and other factors. Typical parameters used for measurement of rollers are to measure the Ra (arithmetic mean deviation), using a λc of 0.08 mm, λs of 2.5 μm, and a stylus with a 90° angle and 5 μm radius tip. Surface roughness may be measured along the surface of the roller in an axial direction, or around the roller surface circumferentially.

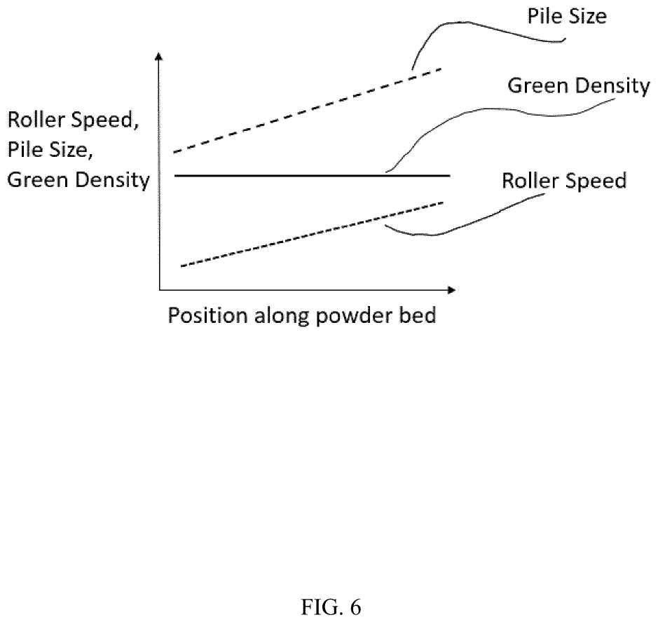

In certain embodiments, roughness may be characterized by any of a number of surface roughness characteristics. One common metric is the arithmetic mean roughness, Ra. Other parameters that may be used include Rz, Rq, Sa, Sz, Sq, or any other measurement of surface texture known in the art. Typical roughness levels that may provide a desirable effect during powder spreading may be in the range of 0.1-0.5 μm Ra, more preferably 0.2-0.4 μm. Roughness measurements may be made using a stylus profilometer, or by optical roughness measurements, or by any suitable measurement. Measurement of roughness may be dependent on the direction (orientation of the measurement). A measurement which is performed around the circumference (FIG. 6) may be preferred to a measurement that is made axially along the roller. This is because residual roughness from the original machining process of the roller may leave ridges along the roller (circumferentially aligned). However, thinking of the relative size of such features, and their movement through the powder bed, a roller which has a high roughness in the axial direction, but a low roughness in the circumferential direction, may not cause the above-described effects during powder spreading.

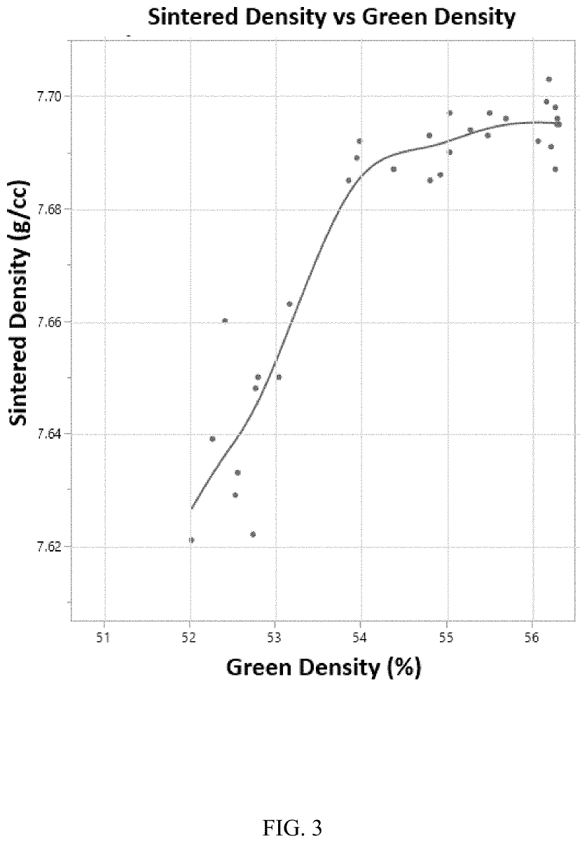

FIG. 3 is a plot of experimentally observed sintered density as a function of green density of printed parts. For parts below a threshold green density, the sintering process will produce parts with a lower final density. Thus, higher green density is desirable from the standpoint of producing parts with higher final density. While sintered density appears to becomes less sensitive to the green density above about 54%, it is still advantageous to increase the green density as the sintering shrinkage will decrease and the shrinkage tolerance will improve.

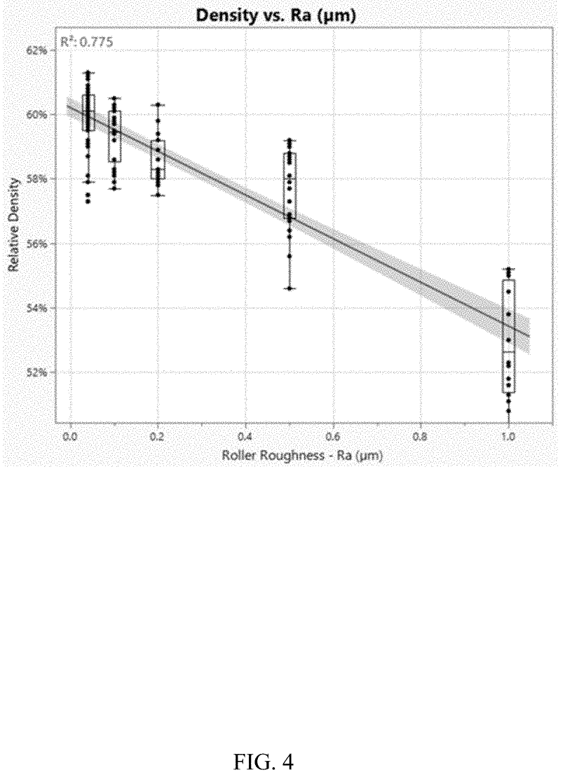

FIG. 4 is an experimentally observed plot of relative density as a function of roughness with other conditions held constant. As the roller speed increases, the relative density of a green part decreases. However, below a critical roughness, which may be approximately Ra 0.05-0.10 μm, the dependence of density on roller speed may be reduced or eliminated.

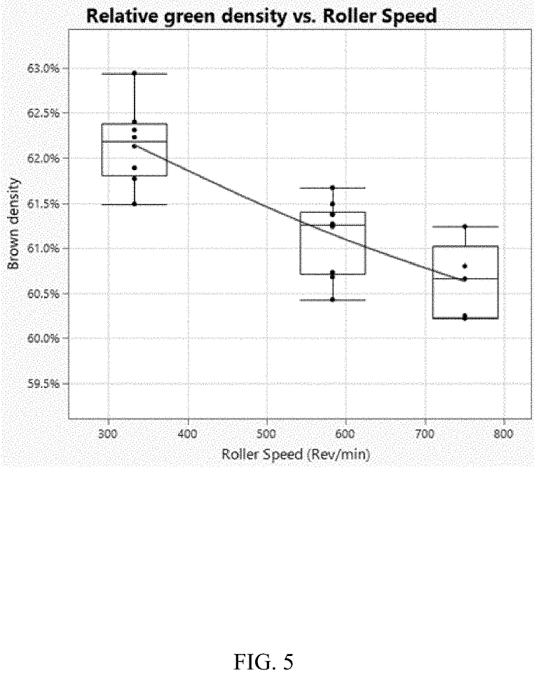

FIG. 5 is an experimentally observed plot of relative green density as a function of roller speed. For a roller with a given roughness, as the roller speed increases, the relative density of a green part decreases. However, below a critical roughness, which may be approximately Ra 0.05-0.10 μm, the dependence of density on roller speed may be reduced or eliminated.

FIG. 6 illustrates that in certain embodiments, roller rotation speed may be varied along the powder bed to counter the effects of increasing (or decreasing) pile size. If pile size tends to increase, rotation speed may be increased. This will result in a constant density of parts across the bed.

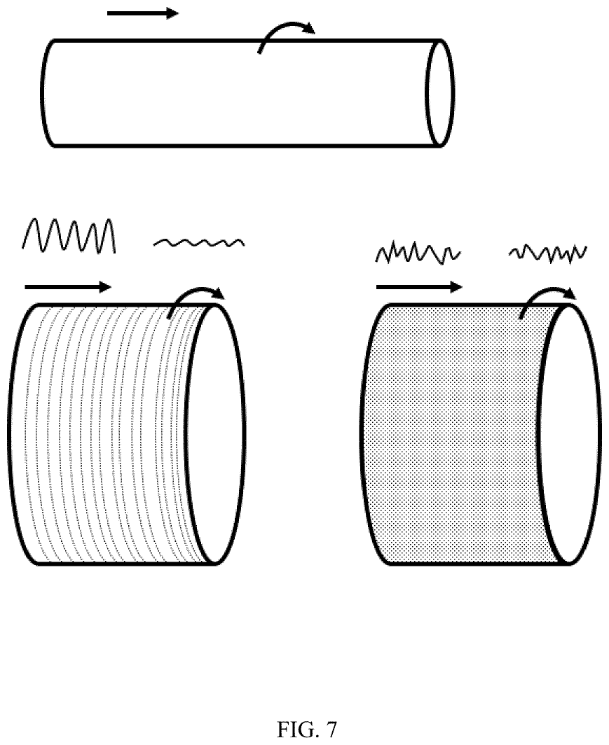

FIG. 7 depicts that measurement of roller roughness around the roller may be with respect to the circumference of the roller and/or along the roller (axial). Circumferential measurement is desirable, as this is more representative of the texture profile that a rotating roller presents to powder particles during layer spreading.

The desired degree of roughness, and the optimal roller speed, may depend on a number of factors, as will be understood by one skilled in the art, which may include:
Powder particle size distribution
   Larger particles may require a higher roughness
Powder cohesion
   More cohesive powder may require a higher roughness, or a higher rotation rate, or both, to avoid transitioning to a jammed state
   Less cohesive powder may require a lower roughness, or lower roller speed, or both, to impart a higher degree of compaction in order to achieve a desired density
Layer thickness during binder jet process
   Thinner layers may require a higher roughness, or a higher rotation rate, or both
Dispensed powder amount (and/or size of the pile being spread)
   Larger amounts of powder being spread may require higher roller rotational speeds or rougher roller, or both
Powder dispensing method
   See below—depends on whether the powder pile size increases or decreases
Traverse Speed
   Depending on the other properties, a higher traverse speed may require a higher or lower rotational speed.
Roller diameter
Roller cleanliness (or roller condition, a coating or state of oxidation, perhaps)
Roller temperature

Roughness may be created by any number of methods, including but not limited to:
Media blasting (sand blasting, grit blasting, bead blasting)
Other abrasion techniques, such as sandpaper
Laser ablation
Electrochemical etching
Machining operations, such as knurling
   A roller may have a roughness which is created to have a helical or spiral pattern. A roller may have a roughness which is created to have a pattern which repeats periodically along the length and/or circumference of the roller.

It should be understood that natural variation induced by a manufacturing process may cause a range of roughness values to be present on a roller. It should be further understood that a specific range of roughness values may have a dominant effect on the performance of the roller, while the remaining aspects of roughness do not have a meaningful contribution.

One dependency that should be highlighted is the effect of powder metering rate (or powder pile size) on the green density. It is observed that for higher metering rates, the density of green part increases. In a system wherein the powder is deposited (continuously) along the bed (for example from a metering device), the size of powder pile may increase from the start to the end of the powder bed, leading to increasing density. Conversely, in a system wherein the powder is spread from a feed piston, the pile is initially charged to a predetermined size or amount, and may decrease along the bed, leading to a decrease in density along the bed.

With the use of a surface conditioned roller and controlling the roller speed along the powder bed, the accumulation or depletion of the pile may be counteracted, enabling the maintenance of a constant powder density across the bed and parts of a constant density to be printed. The required change in roller rotation speed along the bed may vary depending on the properties of the powder, the traverse speed, layer thickness, amount of dispensed powder, or other parameters. In some cases, it may be necessary to calibrate the roller speed by creating parts and measuring the resulting density—in such cases, small cubes with side length of approximately 10 mm may be used as feedback to calibrate the roller speed adjustment. In an embodiment, the roller speed may be increased or decreased by approximately 50% along the powder bed.

In some embodiments a combination of a surface conditioned roller and a pile of granular material in advance of the roller may be useful to resolve differences in powder density imparted by non-uniform metering of powder in advance of the roller and granular material pile.

The powder pile may be considered as an accumulator which permits the roller to accommodate variations in the density and/or mass of granular material deposited on the bed in advance of the roller.

One undesirable effect of increasing the roughness of the roller may be powder sticking to the roller and being pulled over the roller to the trailing edge. This may result in loose powder being deposited on the powder bed after compaction is complete, causing a deviation from the desired smoothness and flatness. This may be ameliorated with the use of a wiper, which may consist of one of a piece of felt or other woven or non-woven cloth material; or a metal, rubber, or plastic scraper; or a combination of one or more materials; the intention being to remove material adhered to the roller as it rotates without interruption to the powder deposition, compaction, and printing processes. With a smoother roller, removal may be easier, as there is less roughness; hence a rough roller may require more wipers, more pressure between the roller and the wiper, or more frequent replacement of the wiper material.

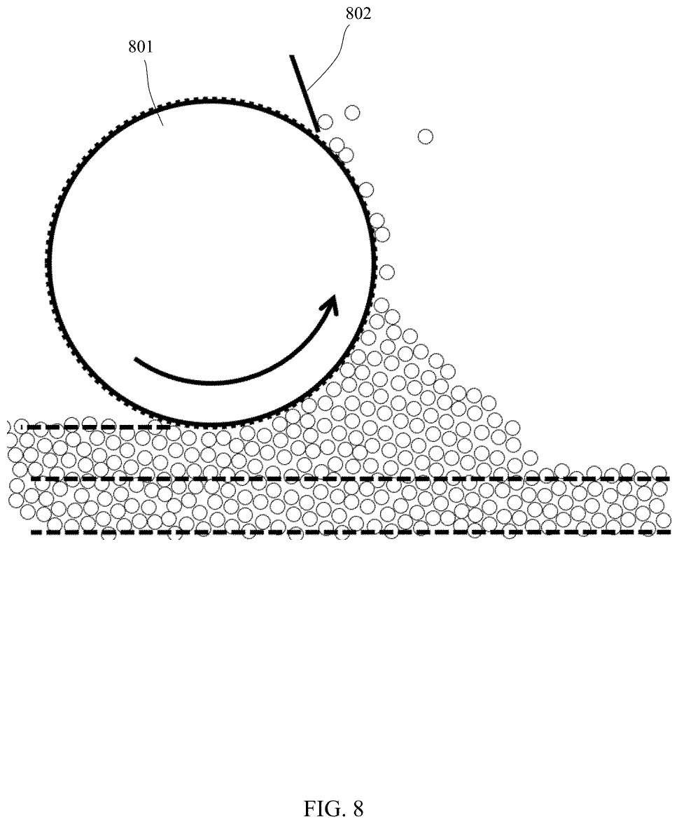

FIG. 8 depicts an embodiment in which a surface conditioned roller 801 includes a wiper or scraper 802 positioned to remove the powder may be employed to prevent powder from being pulled around the roller and depositing on the newly spread layer.

FIG. 9 depicts an embodiment in which a pile of granular material 901 is deposited in advance of a roller 902 (surface conditioning omitted). The pile of granular material may be insufficient to spread powder over the entire bed without additional material being added. This material may be provided at the start of the roller traverse.

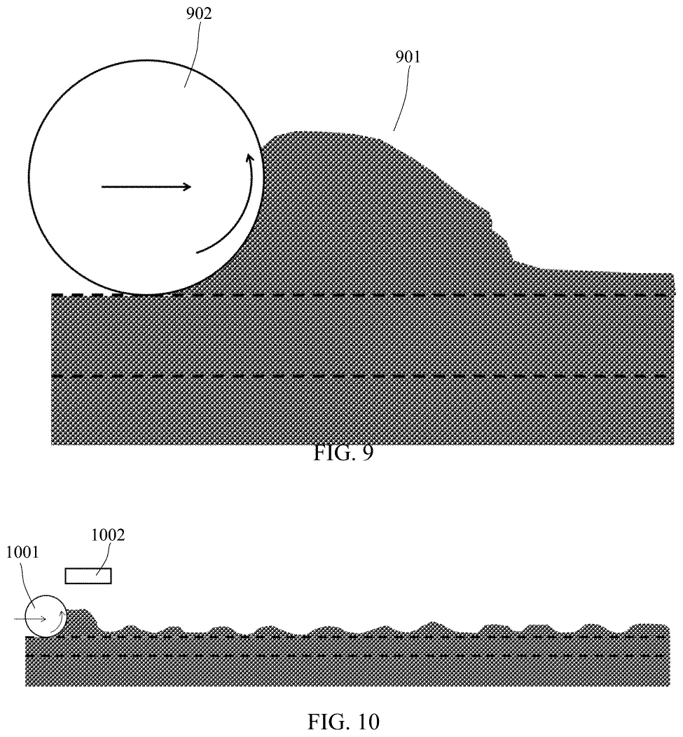

FIG. 10 depicts a roller 1001 traversing a large section of the bed 1002 with variations in the amount of material metered across the bed by powder dispenser system 1003. The powder pile in advance of the roller is deposited to accommodate the variation of deposited powder by alternatively storing or depositing powder when more or less material is present on the surface of the powder bed.

Typical roller size is 20 mm diameter, but may vary between 5 mm and >30 mm. Roller may comprise a solid rod, or a hollow tube. Considerations for diameter are stiffness of roller (i.e. ability to resist deflection across a span), mass and inertia of the roller, and other typical design concerns which will be understood by one skilled in the art.

In a typical process, a 20 mm diameter roller with a traversal speed of 500 mm/s, a surface speed of 175 mm/sec, and a layer thickness of 65 μm may provide a desired degree of compaction in a gas atomized 17-4 PH powder with D90 of 25 μm.

Traversal speeds may be around 500 mm/s, but may vary between 50 mm/s and 1000 mm/s. Roller surface speeds may be in the range of 10-1000 mm/s. The optimal speed may depend on the properties of the powder, with less compressible powder requiring a lower roller speed to achieve a desired degree of compaction, compared to a more compressible powder. The optimal roller surface speed may also depend on other factors such as layer thickness, roller traversal speed, environmental factors (e.g. humidity and temperature), etc.

Particle sizes may depend on the type of powder being used. Typical sizes which provide a desirable combination of spreadability and compressibility may be powders having a D90 in the range of 16 to 25 microns. D90 indicates that 90% of the particles (by volume) have a size smaller than the indicated size, as will be understood by one skilled in the art. Particle size distributions may exhibit a natural distribution (e.g. lognormal) or may have an engineered distribution (e.g. bimodal, trimodal, etc.). It should be understood that the methods described apply to any powder typically used for additive manufacturing processes, which may include larger or smaller particle size distributions.

The roller diameter, in conjunction with the rotation speed and traversal speed, determines the relative surface speed between the roller surface and the powder bed during spreading and traversal of the roller. Rollers of different diameters may be controlled to provide a similar surface speed, at a given traversal speed, by setting the rotation rate such that the tangential speeds are equivalent.

In another aspect, the diameter of the roller determines the shape (angle, volume, etc.) of the pile of powder in front of the roller, with a roller having a larger diameter having a smaller angle (more nearly horizontal) with respect to the powder bed. This may cause the roller to impart a force in a more downward direction (that is into the powder bed) as compared with a roller having a smaller diameter. In one aspect, a roller with a larger roller diameter, all else being equal, may impart a larger compression (compaction) force onto the powder bed during spreading. Therefore it should be understood that the diameter and speed of the roller interact in determining the degree of compression of the powder, along with the surface conditioning of the roller.

What is claimed:

1. A method of conditioning layers of build material powder for metal additive manufacturing, comprising the steps of:
depositing an amount of build material powder on a work surface, the amount of build material powder having a lower surface separated from an upper surface by a height;
traversing a roller across the work surface in a first direction while rotating the roller in a direction opposed to the first direction;
wherein during the step of traversing the roller, a lower surface of the roller extends below the upper surface of the amount of build material powder by a distance; and
wherein the roller has a surface conditioning configured to, in conjunction with a controlled speed of the rotation of the roller, provide a powder density in a compacted layer within a predetermined powder density range.

2. The method of claim 1 wherein the controlled speed of the rotation of the roller and a size of the surface conditioning are selected according to characteristics of the build material powder.

3. The method of claim 1 wherein the controlled speed of the rotation of the roller is varied during the step of traversing the roller.

4. The method of claim 1 wherein step of traversing the roller compacts the new layer of build material powder.

5. The method of claim 1 wherein the surface conditioning is a roughness.

6. The method of claim 1 wherein during the step of traversing the roller, a wiper is disposed against a forward surface of the roller and configured to reduce adherence of the build material powder to the roller.

7. The method of claim 1 wherein during the step of traversing the roller, varying the speed in which the roller is traversed in the first direction.

8. The method of claim 5 wherein the speed in which the roller is traversed is increased.

9. The method of claim 1 wherein the surface conditioning is an arithmetic mean roughness between and inclusive of 0.1 and 0.5 μm.

10. The method of claim 1 wherein the work surface is a build plate.

11. The method of claim 1 wherein the work surface is a previously deposited layer of the build material powder.

12. The method of claim 1 wherein, during the step of traversing, depositing an amount of powder in advance of the roller.

13. The method of claim 1 wherein the steps of depositing an amount of build material and traversing the roller are done simultaneously.

14. The method of claim 1 wherein the predetermined powder density range is selected from the group of 55%-64%, 58-62% and 60-61%.

15. A system for conditioning layers of build material powder in metal additive manufacturing, comprising:
a powder dispensing system configured to deposit an amount of build material powder on a work surface, the amount of build material powder having a lower surface separated from an upper surface by a height;
a roller configured to traverse the work surface in a first direction while rotating the roller in a direction opposed to the first direction;
wherein the roller is configured to, while traversing, have a lower surface of the roller that extends below the upper surface of the amount of build material powder by a distance; and
wherein the roller has a surface conditioning configured to, in conjunction with a controlled speed of the rotation of the roller, provide a powder density in a compacted layer within a predetermined powder density range.

16. The system of claim 15 wherein the controlled speed of the rotation of the roller is configured to be increased as the roller traverses the work surface.

17. The system of claim 15 wherein the surface conditioning is a circumferential texturing.

18. The system of claim 15 further comprising a wiper disposed against a forward surface of the roller and configured to reduce adherence of the build material powder to the roller during traversal of the roller.

19. The system of claim 15 wherein the surface conditioning is an arithmetic mean roughness between and inclusive of 0.1 and 0.5 μm.

20. A method of conditioning layers of build material powder for metal additive manufacturing, comprising the steps of:
depositing a new layer of build material powder on a work surface, the layer of build material powder having a lower surface separated from an upper surface by a height;
traversing a roller over a work surface in a first direction while rotating the roller in a direction opposed to the first direction;
wherein during the step of traversing the roller, a lower surface of the roller extends below the upper surface of the new layer of build material powder by a distance;
wherein the roller has a surface conditioning configured to recirculate the build material powder in the new layer of build material powder.
